(19) United States
(12) Patent Application Publication
(10) Pub. No.: US 2008/0019150 A1
(43) Pub. Date: Jan. 24, 2008

(54) Backlight unit for portable terminal

(75) Inventors: Joong-Wan Park, Suwon-si (KR); Seong-Ha Park, Suwon-si (KR)

Correspondence Address: CHA & REITER, LLC, 210 ROUTE 4 EAST STE 103, PARAMUS, NJ, 07652, US

(73) Assignee: Samsung Electronics Co.; Ltd.

(21) Appl. No.: 11/787,930

(22) Filed: Apr. 18, 2007

(30) Foreign Application Priority Data
Jul. 19, 2006 (KR) 67496/2006

(51) Int. Cl. F21V 8/00

(52) U.S. Cl. 362/621

(57) ABSTRACT

A Backlight Unit (BLU) of a portable terminal and a Light Guide Panel (LGP) are disclosed. The BLU includes an LGP having upper and lower surfaces facing each other and first and second side surfaces located between the upper and lower surfaces and facing each other and allowing light to travel therethrough by means of internal reflection between the upper and lower surfaces; at least one light source arranged to face the first side surface and outputting light to the inside of the LGP; and at least one light extracting pattern formed on the LGP to output the light traveling through the LGP to the outside of the LGP. An edge part of the LGP, where the first side surface is disposed, includes at least one inclined plane inclined from at least one of the upper and lower surfaces to the first side surface.

### CLAIM OF PRIORITY

This application claims priority under 35 U.S.C. §119 to a Patent Application entitled “Backlight Unit for Portable Terminal,” filed in the Korean Intellectual Property Office on Jul. 19, 2006 and assigned Serial No. 2006-67496, the contents of which are incorporated herein by reference.

### BACKGROUND OF THE INVENTION

1. Field of the Invention

The present invention relates generally to a backlight unit (BLU), and in particular, to a BLU using a Light Guide Panel (LGP) installed in a portable terminal such as a cellular phone.

2. Description of the Related Art

FIG. 1 is a side view of a conventional backlight unit (BLU) 100 for a portable terminal. Referring to FIG. 1, the BLU 100 includes a reflecting panel 140, a plurality of light sources 130, a Light Guide Panel (LGP) 110, first and second diffusing panels 150 and 180, and first and second prism sheets 160 and 170. In a coordinate system shown in FIG. 1, a Z axis represents a lighting direction of the BLU 100 (i.e., the direction normal to an upper surface 114 of the LGP 110), a Y axis represents a traveling direction of light output from the plurality of light sources 130, and an X axis represents a direction perpendicular to the Y and Z axes. On the BLU 100 along the Z axis, a liquid crystal panel (not shown) including lower and upper polarizers and a liquid crystal located between the lower and upper polarizers and having a color filter and a Thin Film Transistor (TFT) may be disposed.

The LGP 110 has the upper surface 114 and a lower surface 112 facing each other and first and second side surfaces 116 and 118 located between the upper and lower surfaces 114 and 112 and facing each other. The plurality of light sources 130 face the first side surface 116 of the LGP 110 and output light toward the first side surface 116 of the LGP 110. The LGP 110 guides the light input inside through the first side surface 116 to the second side surface 118 by total internal reflection between the upper and lower surfaces 114 and 112. The LGP 110 includes a plurality of light extracting patterns 120 formed on the lower surface 112. Each of the plurality of light extracting patterns 120 diffusely reflects incident light. Each of the plurality of light extracting patterns 120 violates a total internal reflection condition at a boundary between the LGP 110 and an external air layer so that the light diffusely reflected by each of the plurality of light extracting patterns 120 is transmitted through the upper surface 114.

The reflecting panel 140 is arranged such that its upper surface faces the lower surface 112 of the LGP 110. The reflecting panel 140 reflects light transmitted through the lower surface 112 of the LGP 110 due to the plurality of light extracting patterns 120 to the inner portion of the LGP 110.

The first diffusing panel 150 is arranged such that its lower surface faces the upper surface 114 of the LGP 110. The first diffusing panel 150 scatters and transmits incident light.

The first prism sheet 160 is arranged such that its lower surface faces the upper surface of the first diffusing panel 150. The first prism sheet 160 includes a substrate 162 and a plurality of prism mountains 164 projected from an upper surface of the substrate 162, where the peaks of the prism mountains 164 are parallel and separated from one another. The plurality of prism mountains 164 extend along the Y axis (i.e., along the direction normal to the first side surface 116 of the LGP 110). The first prism sheet 160 concentrates and transmits light incident upon its cross section, on the X-Z plane.

The second prism sheet 170 is arranged such that its lower surface faces the upper surface of the first prism sheet 160. The second prism sheet 170 includes a substrate 172 and a plurality of prism mountains 174 projected from an upper surface of the substrate 172, where the peaks of the prism mountains 174 are parallel and separated from one another. The plurality of prism mountains 174 extend along the X axis, in a direction perpendicular to the direction normal to the first side surface 116 of the LGP 110. The second prism sheet 170 concentrates and transmits light incident upon its cross section, on the Y-Z plane.

The second diffusing panel 180 is arranged such that its lower surface faces the upper surface of the second prism sheet 170 and scatters and transmits incident light.

A Light Emitting Diode (LED) having good color reproducibility can be used as the plurality of light sources 130, and the number of light sources 130 is 3.

FIG. 2 depicts luminance distribution of the upper surface 114 of the LGP 110. In the luminance distribution, a relatively bright portion has higher luminance, and a relatively dark portion has lower luminance. As illustrated in FIG. 2, the first side surface 116 of the LGP 110 has a plurality of hot spots with maximum luminance, and the number of hot spots is equal to the number of light sources 130. The hot spots are caused by light incident upon the upper and lower surfaces 114 and 112 of the LGP 110 with an angle smaller than, but close to a critical angle of the light incident upon the plurality of light extracting patterns 120. The hot spots decrease general illumination luminance and luminance uniformity.

The minimum angle of the light incident upon the upper and lower surfaces 114 and 112 of the LGP 110 is determined by the maximum radiation angle, i.e., Maximum Far-Filed Angle (MFFA), of each light source 130. Thus, using LEDs having a small maximum radiation angle is advantageous, as such LEDs address the hot spot problem. In particular, when such LEDs are used, the maximum radiation angle includes the effective radiation angle, as only light within an effective radiation angle among the light output from the plurality of light sources 130 may be used.

The maximum radiation angle of conventional LEDs is as large as a full width of half maximum reaching 60°. Here, the radiation angle is based on the direction perpendicular to an output surface of an LED. If the maximum radiation angle of an LED is smaller, the price of the LED increases enormously. Thus, it is difficult to apply expensive LEDs to a BLU of a portable terminal.

### SUMMARY OF THE INVENTION

Accordingly, the present invention has been made to solve the problems and/or disadvantages occurring in the prior art, and to provide additional advantages. In particular, the present invention provides a Backlight Unit (BLU) of a portable terminal for enhancing general illumination luminance and luminance uniformity by decreasing a hot spot phenomenon attributable to a large radiation angle of the light sources.

According to one aspect of the present invention, there is provided a BLU of a portable terminal, the BLU comprising: a Light Guide Panel (LGP) having upper and lower surfaces facing each other and first and second side surfaces located between the upper and lower surfaces and facing each other and allowing light to travel therethrough by means of internal reflection between the upper and lower surfaces; at least one light source arranged to face the first side surface and outputting light to the inside of the LGP; and at least one light extracting pattern formed on the LGP to output the light traveling through the LGP to the outside of the LGP, wherein an edge part of the LGP, which comprises the first side surface, further comprises at least one inclined plane inwardly inclined from at least one of the upper and lower surfaces to the first side surface.

### BRIEF DESCRIPTION OF THE DRAWINGS

The above features and advantages of the present invention will become more apparent from the following detailed description when taken in conjunction with the accompanying drawing in which:

FIG. 1 is a side view of a conventional backlight unit (BLU) for a portable terminal;

FIG. 2 depicts luminance distribution of an upper surface of a Light Guide Panel (LGP) illustrated in FIG. 1;

FIG. 3 is a side view of a BLU for a portable terminal according to a first aspect of the present invention;

FIG. 4 is a diagram for describing a function of first and second inclined planes illustrated in FIG. 3;

FIG. 5 is a magnified diagram of a corner of an edge part of a LGP, which is illustrated in FIG. 4;

FIG. 6 is a graph showing correlations between the maximum radiation angle of each light source and inclined angles of the first and second inclined planes;

FIG. 7 depicts luminance distribution of an upper surface of the LGP illustrated in FIG. 3; and

FIG. 8 is a cross-sectional view of a keypad assembly according to a second aspect of the present invention.

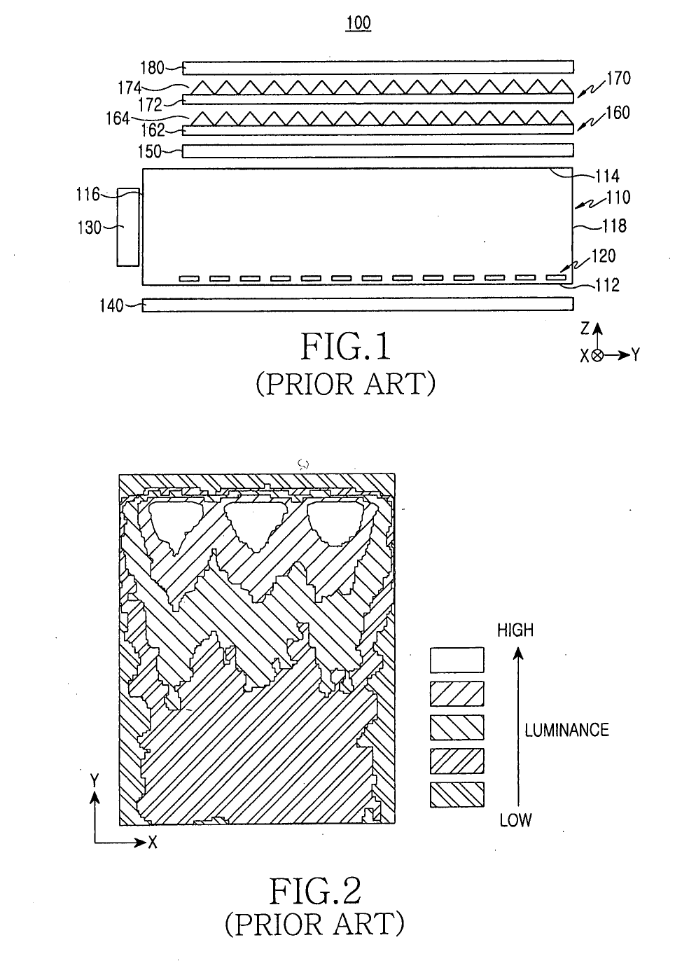

### DETAILED DESCRIPTION OF THE EMBODIMENT

Hereinafter, several aspect of the present invention will be described with references to the accompanying drawings. For the purposes of clarity and simplicity, well-known functions and configurations are omitted as the description of known function and configuration may make the present invention rather unclear.

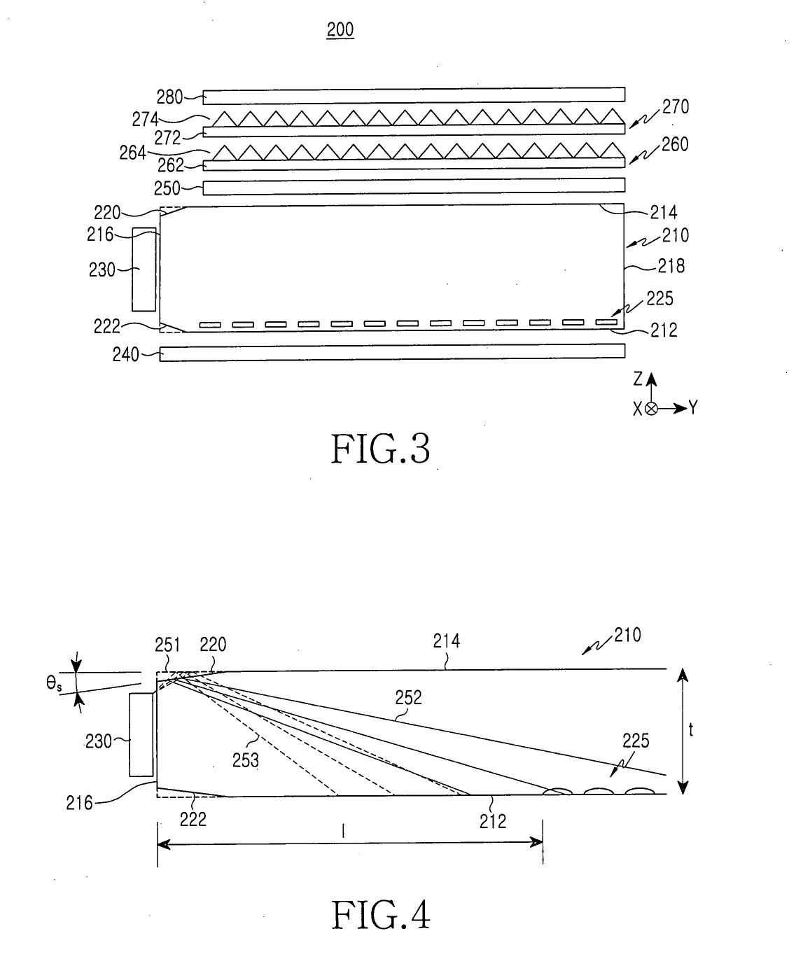

FIG. 3 is a side view of a Backlight Unit (BLU) 200 for a portable terminal according to a first aspect of the present invention. Referring to FIG. 3, the BLU 200 includes a reflecting panel 240, a plurality of light sources 230, a Light Guide Panel (LGP) 210, first and second diffusing panels 250 and 280, and first and second prism sheets 260 and 270. In a coordinate system shown in FIG. 3, the Z axis represents a lighting direction of the BLU 200 (in other words, the normal of an upper surface 214 of the LGP 210), the Y axis represents a traveling direction of light output from the plurality of light sources 230, and the X axis represents a direction perpendicular to the Y and Z axes. On the BLU 200 along the Z axis, a liquid crystal panel (not shown) may be disposed. The liquid crystal panel (not shown) may include lower and upper polarizers, a liquid crystal located between the lower and upper polarizers, a color filter, and a Thin Film Transistor (TFT).

The LGP 210 generally is in a form of a rectangular parallelepiped and has the upper surface 214 and a lower surface 212 facing each other and first and second side surfaces 216 and 218, located between the upper and lower surfaces 214 and 212, facing each other. The plurality of light sources 230 face the first side surface 216 of the LGP 210 and output light toward the first side surface 216 of the LGP 210. The LGP 210 guides the light input through the first side surface 216 to the second side surface 218 by total internal reflection between the upper and lower surfaces 214 and 212. The LGP 210 may be produced by, for example, injection molding of a polycarbonate or acryl-based resin.

The LGP 210 includes a plurality of light extracting patterns 225 formed on the lower surface 212. Each of the plurality of light extracting patterns 225 diffusely reflects incident light. In other words, each of the plurality of light extracting patterns 225 prevents the total internal reflection condition at the boundary of the LGP 210 and external air such that the light is diffusely reflected by each of the plurality of light extracting patterns 225 and transmitted through the upper surface 214 of the LGP 210. Each of the plurality of light extracting patterns 225 may have, for example, a scratch, micro-hemisphere, corrugation, or prism pattern formed by process including printing, photolithography, lasing, and stamping.

The plurality of light extracting patterns 225 may be provided as a form of a Bragg grating having a periodic change of a refractive index, which may be implemented by means including polling and Infrared (IR) irradiation. In addition, the plurality of light extracting patterns 225 may be formed on the upper surface 214 of the LGP 210.

Referring to FIGS. 3 and 4, an edge portion of the LGP 210, near the first side surface 216, includes a first inclined plane 220 with an inclined angle of θ_{S}. In addition, the edge portion of the LGP 210 includes a second inclined plane 222 inwardly inclined at the angle of θ_{S}. Here, the inclined angle, θ_{S}, is defined as an angle between the inclined plane and an imaginary plane that is parallel to either upper or lower surface and that extends above or below the inclined plane. In other words, each of the first and second inclined planes 220 and 222 is inwardly inclined from the upper or lower surface 214 or 212 to the first side surface 216, from the position separated from the first side surface 216.

FIG. 4 is a diagram for describing a function of the first and second inclined planes 220 and 222. In FIG. 4, an imaginary, extended plane 251 obtained by extending the upper surface 214 of the LGP 210, such that the LGP 210 is without the inclined plane 222, is illustrated with a dotted line; the light 252 reflected by the first inclined plane 220 is illustrated with a thin solid line; and imaginary light 253 reflected by the imaginary extended plane 251 is illustrated with a thin dotted line. In addition, t denotes the thickness of the LGP 210, and l denotes the distance between the first side surface 216 of the LGP 210 and the start position of the plurality of light extracting patterns 225. As shown in FIG. 4, the imaginary 253 light reflected by the imaginary extended plane 251 is incident on a portion of the lower surface 212, between the first side surface 216 and the plurality of light extracting patterns 225.

This phenomenon is caused as the angle of reflection of the imaginary light 253 is small and close to a critical angle, based on the normal of the upper surface 214 of the LGP 210. Commonly, based on the normal of an arbitrary flat plane, an angle between the incident light and the normal to the arbitrary plane is equal to the angle between the reflected light and the normal to the arbitrary flat plane.

As the first inclined plane 220 is inwardly inclined toward the first side surface 216 from the extension of the upper surface 214, the first inclined plane 220 increases the angle of incidence of incident light by θ_{S}, compared to the extended plane 251. For example, based on the normal of the upper surface 214 of the LGP 210, if it is assumed that an angle of the light incident to the extended plane is θₗ, an angle of incidence of light incident to the first inclined plane 220 is θₗ+θ_{S}. Thus, an angle of reflection of light reflected from the first inclined plane 220 is also θₗ+θ_{S}. Likewise, the second inclined plane 222 increases an angle of incidence of incident light by θ_{S}.

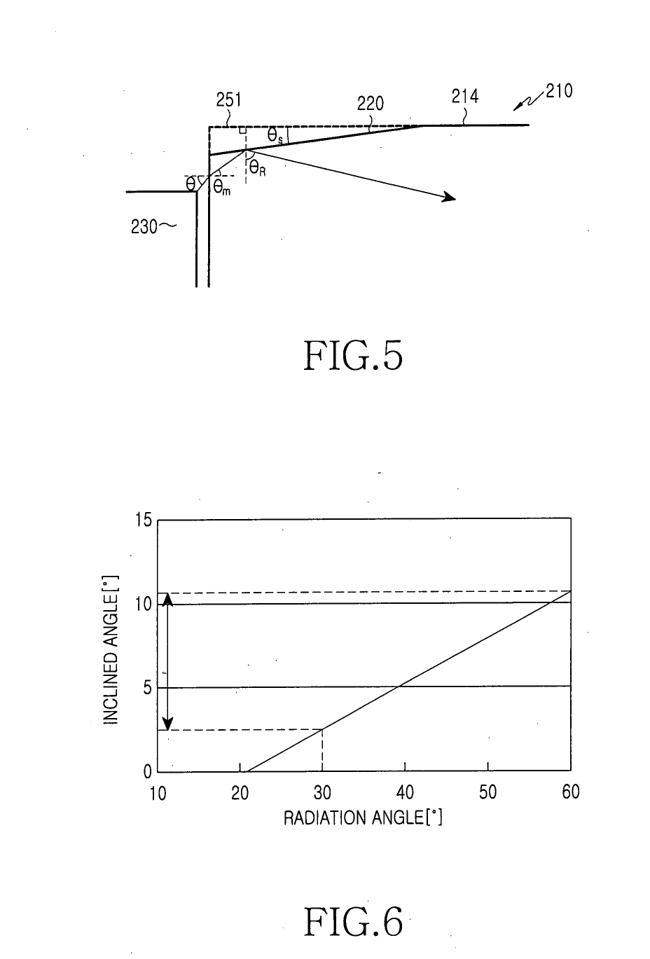

FIG. 5 is a magnified diagram of a corner of the edge part of the LGP 210, which includes the first side surface 216. FIG. 5 illustrates the principle of setting an inclined angle of the first or second inclined plane 220 or 222. If it is assumed that the maximum radiation angle of each light source 230 is θ, the condition for delivering the light reflected by the first inclined plane 220 to a position farther than the start position of the plurality of light extracting patterns 225 can be represented by Formula 1.

θ_{R}=π/2−θₘ+2θ_{S}≧tan⁻¹(l/t) (1)

Here, θ_{R} denotes an angle of reflection of light having the maximum radiation angle, which is reflected by the first inclined plane 220, based on the normal of the upper surface 214 of the LGP 210, and θₘ denotes an angle of refraction of light having the maximum radiation angle based on the first side surface 216.

A person of ordinary skilled in the art will appreciate that Formula 1 suggests an exemplary condition, and this condition is not limited thereto. In addition, Formula 1 is an approximate formula, based on an assumption that the distance of the light traveling from the first side surface 216 to the extended plane 251 is negligible in comparison to the distance of the light traveling from the extended plane 251 to the lower surface of the LGP 210.

Formula 2 is derived from Formula 1.

θ_{S}≧[θₘ−π/2+tan⁻¹(l/t)]/2 (2)

If the refractive index of the LGP 210 is n, and as the refractive index of the air is 1, θₘ may be derived, as shown in Formula 3, according to the Snell's law.

θₘ=sin⁻¹(sin θ/n) (3)

Formula 4 is derived from Formulas 2 and 3.

θ_{S}≧[sin⁻¹(sin θ/n)−π/2+tan⁻¹(l/t)]/2 (4)

FIG. 6 is a graph showing the correlations between the maximum radiation angle of each light source 230 and inclined angles of the first and second inclined planes 220 and 222. The graph illustrated in FIG. 6 is based on Formula 4, wherein the value of t is, for example, 0.55 mm, the value of l is, for example, 1.5 mm, and the value of n is, for example, 1.52.

Thus, if a light source has the maximum radiation angle in a range between 30° and 60°, the inclined angles of the first and second inclined planes 220 and 222 have a range between 2.5° and 10°. It is preferable that the first inclined plane 220 be extended from the first side surface 216 to a point on the upper surface 214 such that light reflected by the first inclined plane 220 of the LGP 210 may reach the start position of the plurality of light extracting patterns 225 or farther. The second inclined plane 222 is extended the same as the first inclined plane 220.

Referring back to FIG. 3, the reflecting panel 240 is arranged below the LGP 210 such that its upper surface faces the lower surface 212 of the LGP 210. The reflecting panel 240 reflects the light transmitted through the lower surface 212 of the LGP 210 back to the LGP 210.

The first diffusing panel 250 is arranged on the LGP 210 such that the lower surface of the diffusing panel 250 faces the upper surface 214 of the LGP 210. The first diffusing panel 250 scatters and transmits incident light.

The first prism sheet 260 is arranged on the first diffusing panel 250 such that lower surface of the first prism sheet 260 faces the upper surface of the first diffusing panel 250. The first prism sheet 260 includes a substrate 262 and a plurality of prism mountains 264 projected from the upper surface of the substrate 262, where the peaks of the prism mountains 264 are parallel and separated from one another. The plurality of prism mountains 264 extend along the Y axis, along the axis normal to the first side surface 216 of the LGP 210. The first prism sheet 260 concentrates and transmits incident light on its cross section, on the X-Z plane.

The second prism sheet 270 is arranged on the first prism sheet 260 such that the lower surface of the prism sheet 270 faces the upper surface of the first prism sheet 260. The second prism sheet 270 includes a substrate 272 and a plurality of prism mountains 274 projected from the upper surface of the substrate 272, where the peaks of the prism mountains 274 are separated and in parallel to one another. The plurality of prism mountains 274 extend along the X axis, along a direction perpendicular to the direction that is normal to the first side surface 216 of the LGP 210. The second prism sheet 270 concentrates and transmits incident light on its cross section, on the Y-Z plane.

The second diffusing panel 280 is arranged on the second prism sheet 270 such that the lower surface of the diffusing panel 280 faces the upper surface of the second prism sheet 270. The second diffusing panel 280 scatters and transmits incident light.

Light Emitting Diodes (LED) having good color reproducibility may be used as the plurality of light sources 230. The number of light sources 230 may be 2.

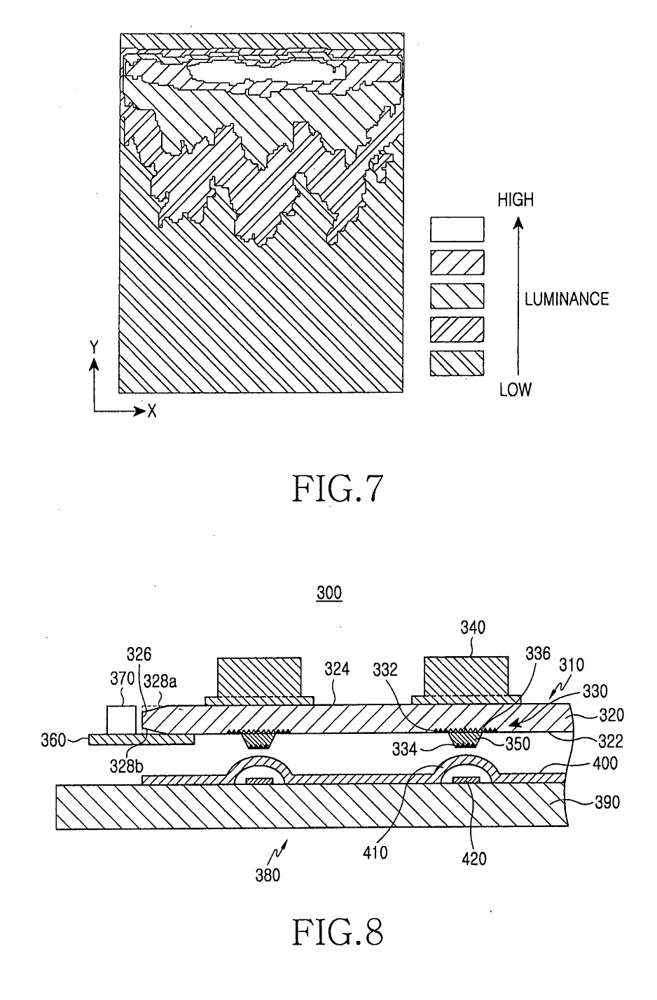

FIG. 7 illustrates the luminance distribution of the upper surface 214 of the LGP 210. In the luminance distribution, a relatively bright portion has higher luminance, and a relatively dark portion has lower luminance. As illustrated in FIG. 7, the edge portion of the LGP 210, which includes the first side surface 216, has a plurality of hot spots having the maximum luminance, and the number of hot spots is equal to the number of light sources 230. Although the number of light sources is different, it can be seen that the size and luminance of the hot spots are significantly less than those of the existing BLU.

As described above, the BLU 200 according to the first aspect of the present invention can be applied to Liquid Crystal Display (LCD) devices and may have various usages by various modifications.

The second aspect of the present invention illustrates a BLU corresponding to a keypad including the LGP 320 with inclined planes 328a and 328b. As the principle behind the inclined planes has been described in the description of the preceding aspect of the present invention, the inclined planes will not be described in detail.

FIG. 8 is a cross-sectional view of a keypad assembly 300 according to the second aspect of the present invention. Referring to FIG. 8, the keypad assembly 300 includes a BLU 310, and a switch board 380 that is arranged separately from the BLU 310.

The BLU 310 includes a LGP 320, a plurality of key buttons 340, a plurality of protrusions (or actuators) 350, a plurality of light extracting patterns 330, a plurality of light sources 370, and a second Printed Circuit Board (PCB) 360.

The LGP 320 generally is in a form of a rectangular parallelepiped. The LGP 320 has upper and lower surfaces 324 and 322, facing each other, and a first side surface 326 and a second side surface (not shown), facing each other, located between the upper and lower surfaces 324 and 322. The LGP 320 guides light input through the first side surface 326.

The input light travels from the first side surface 326 of the LGP 320 to the second side surface. The light input to the LGP 210 travels through the LGP 210 by total internal reflection between the LGP 320 and external air. An edge portion of the LGP 320 including the first side surface 326 also includes a first inclined plane 328a and a second inclined plane 328b. The first inclined plane 328a inwardly inclined at a pre-set angle from the upper surface 324 to the first side surface 326, whereas the second inclined plane 328b inwardly inclined at the pre-set angle from the lower surface 322 to the first side surface 326.

As the LGP 320 has elasticity, when a key button 340 located above the LGP 320 is pressed, the LGP 320 places the pushed key button 340 to its original position. That is, as the LGP 320 has a force of self-restoration, when the LGP 320 is strained, the LGP 320 is restored by itself. Thus, when any key button 340 is pushed, the LGP 320 places the pushed key button 340 to its original position.

The LGP 320 has characteristics of generating superior click feeling, preventing interference between key buttons 340. The LGP 320 may be made from a highly transparent rubber material having low rigidity, high elastic strain, high force of elastic restoration, and high optical transmittance such that the strain does not remain on the LGP 320 despite repeated operations. Preferably, the LGP 320 is formed by a material such as, for example, polyurethane, silicone, or the like.

The second PCB 360 is attached to a marginal portion of the lower surface 322 of the LGP 320. The plurality of light sources 370 are disposed on an upper surface of the second PCB 360 such that the output surface of each light source 370 faces the first side surface 326 of the LGP 320. Light emitted from the plurality of light sources 370 is input to the LGP 320 through the first side surface 326. A common Flexible PCB (FPCB), for example, may be used as the second PCB 360, and common LEDs, for example, may be used as the plurality of light sources 370.

The plurality of key buttons 340 protrude from the upper surface 324 of the LGP 320. Meanwhile, letters, numbers, and others characters may be imprinted on the plurality of key buttons 340. The plurality of key buttons 340 can be formed as a single piece using same or different material from that of the LGP 320. Alternatively, the plurality of key buttons 340 may be formed from a material such as, for example, polycarbonate or acryl-based resin, and attached to the upper surface 324 of the LGP 320. Each of the plurality of key buttons 340 may have any shape including the shape of a cylinder and a cylindroid.

The plurality of protrusions 350 protrude from the lower surface 322 of the LGP 320. The plurality of protrusions 350 may be formed as a single piece using the same or different material from that of the LGP 320. Alternatively, the plurality of protrusions 350 may be separately formed and attached to the lower surface 322 of the LGP 320. The plurality of protrusions 350 may have any shape, such as, for example, a truncated cone or a trapezoidal hexahedron. The plurality of protrusions 350 are respectively arranged below the plurality of key buttons 340, in the thickness direction of the keypad assembly 300 or in the direction perpendicular to an upper surface of a first PCB 390.

The BLU 310 has the plurality of light extracting patterns 330 (indicated by black-colored triangles) formed on the lower surface 322 of the LGP 320, where each light extracting pattern 330 reflects a portion of light traveling through the LGP 320 to a corresponding key button 340. If necessary, the plurality of light extracting patterns 330 may be formed on the upper surface 324 of the LGP 320.

The plurality of light extracting patterns 330 allows uniform illumination to the plurality of key buttons 340 as the plurality of light extracting patterns 330 are formed on and around the plurality of protrusions 350 located below the plurality of key buttons 340. By varying the density or size of light extracting patterns 330 located relatively close to the plurality of light sources 370 from the density or size of light extracting patterns 330 located relatively far from the plurality of light sources 370, the entire distribution of the intensity of light emitted toward the upper surface 324 of the LGP 320 may be controlled regardless of distances between the plurality of light extracting patterns 330 and the plurality of light sources 370. For example, by increasing density or size of the light extracting patterns 330 located closer to the plurality of light sources 370 relative to the light extracting patterns 330 located farther from the plurality of light sources 370, the entire distribution of the intensity of emitted light, i.e., the entire illumination distribution of the plurality of key buttons 340, may be controlled to be uniform.

As illustrated in FIG. 8, the central portion 334 of each light extracting pattern 330 is formed on a lower surface of a corresponding protrusion 350, whereas the marginal portion 332 of the light extracting pattern 330 is formed around the protrusion 350. The light traveling with total internal reflection in the LGP 320 is incident to the light extracting pattern 330. As most of the light diffusely reflected toward a corresponding key button 340 by the light extracting pattern 330 does not satisfy the total internal reflection condition, where the incident angel is smaller than a critical angle, the light is transmitted to the key button 340.

Meanwhile, light that is not diffusely reflected by the light extracting pattern 330 and a portion of the light diffusely reflected, but satisfies the total reflection condition, travel through the LGP 320 continuously via internal reflection. Such light may illuminate other key buttons 340. That is, each light extracting pattern 330 diffusely reflect and transmits only a portion of the incident light to a particular key button 340. As such, portion of the incident light not transmitted to a particular key button and light not diffusely reflected by a particular light extracting pattern 330 may be transmitted to other key buttons 340. Therefore, the plurality of light extracting patterns 330 achieves uniform illumination of the plurality of key buttons 340, as the plurality of light extracting patterns 330 diffusely reflecting the incident light toward arbitrary directions. Preferably, the plurality of light extracting patterns 330 can be formed by scratching or imprinting.

A central portion 336, as illustrated by white-colored triangles in FIG. 8, of each light extracting pattern 330 may be formed between the LGP 320 and a corresponding protrusion 350, instead of being formed on the lower surface of the protrusion 350.

The switch board 380 is disposed below the BLU 310 and includes the first PCB 390 and a dome sheet 400.

The first PCB 390 includes a plurality of conductive contact members 420, and each contact member 420 forms a switch 410 and 420 together with a corresponding dome 410. Each switch 410 and 420 is arranged below a corresponding protrusion 350.

The dome sheet 400 is attached to the upper surface of the first PCB 390 and includes a plurality of conductive domes 410 having a hemispherical shape, wherein each dome 410 fully covers corresponding contact member 420.

When a user pushes a key button 340, a portion of the BLU 310, which is located below the pushed key button 340, is strained toward the switch board 380 As such, a protrusion 350 corresponding to the strained portion pushes a corresponding dome 410. The pushed dome 410 achieves an electrical contact with the corresponding contact member 420.

In the present invention, various changes in form and details may be made without departing from the spirit and scope of the invention. For example, although a LGP is disclosed to include first and second inclined planes, the LGP may include any one of the first and second inclined planes.

In addition, although the light extracting patterns with different density or size is disclosed in the second aspect of the present invention, such light extracting patterns may also be applied to the first aspect of the present invention.

As described above, a BLU for a portable terminal including a LGP with at least one inclined plane at an edge part the BLU, the BLU can reduce a hot spot phenomenon attributable to a large radiation angle of the light sources, thereby enhancing general illumination luminance. At the same time the BLU may luminance uniformity compared to the conventional BLU.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A Backlight Unit (BLU) of a portable terminal, the BLU comprising:
a Light Guide Panel (LGP) having upper and lower surfaces that face each other and first and second side surfaces that are located between the upper and lower surfaces and that face each other, the LGP being configured to allow light to travel therethrough by internal reflection between the upper and lower surfaces;
at least one light source being arranged to face the first side surface and being configured to output light to the inside of the LGP; and
at least one light extracting pattern being formed on the LGP and being configured to output the light traveling through the LGP to the outside of the LGP,
wherein an edge part of the LGP, the edge part where the first side surface is disposed, comprises at least one inclined plane being inclined from the first side surface to at least one of the upper and lower surfaces.

2. The BLU of claim 1, wherein the inclined plane has an inclined angle in a range between 2.5° and 10°.

3. The BLU of claim 1, wherein the light extracting pattern is being formed on the lower surface of the LGP and being configured to diffusely reflect incident light toward the upper surface of the LGP.

4. The BLU of claim 1, further comprising at least one diffusing panel being disposed on the LGP and being configured to scatter and transmit incident light.

5. The BLU of claim 1, further comprising at least one prism sheet being disposed on the LGP and being configured to concentrate and transmitting incident light.

6. The BLU of claim 1, further comprising at least one reflecting panel being disposed below the LGP and being configured to reflect light transmitted through the lower surface of the LGP toward the LGP.

7. The BLU of claim 1, further comprising at least one key button disposed on the upper surface of the LGP.

8. The BLU of claim 7, wherein the LGP is configured to restore the key button to its original position after the key button operates.

9. The BLU of claim 1, further comprising at least one protrusion being disposed on the lower surface of the LGP.

10. The BLU of claim 9, wherein the light extracting pattern is being disposed on and around the protrusion.

11. The BLU of claim 1, wherein the first side surface of the LGP is perpendicular to the upper surface.

12. The BLU of claim 1, wherein the second side surface of the LGP has a larger surface area than the first side surface.

13. A Light Guide Panel (LGP) comprising
upper and lower surfaces that are disposed on opposite sides of the LGP;
first and second side surfaces that are disposed between the upper and lower surfaces and that face each other; and
at least one inclined plane adjoined to the first side surface and one of the upper and lower surfaces,
wherein the first side surface is configured to input light to the LGP, and
wherein the LGP is configured to transmit the light input therein by internal reflection.

14. The LGP of claim 13, wherein the at least one inclined plane has an inclined angle in a range between 2.5° and 10°.

15. The LGP of claim 13, wherein the first side surface is perpendicular to the upper surface.

16. The LGP of claim 13, wherein the second side surface has a larger surface area than the first side surface.

17. The LGP of claim 13, wherein the LGP is configured to restore its original shape after experiencing deflection.

18. A method for providing a Backlight Unit (BLU) of a portable terminal, the method comprising:
providing a Light Guide Panel (LGP) having upper and lower surfaces that are disposed on opposite sides of the LGP, and first and second side surfaces that face each other and that are disposed between the upper and lower surfaces, and at least one inclined plane adjoined to the first side surface and one of the upper and lower surfaces, the LGP being configured to transmit light input therein by internal reflection; and
providing at least one light source that is configured to input light into the LGP.

19. The method of claim 18, wherein the at least one inclined plane has an inclined angle in a range between 2.5° and 10°.

20. The method of claim 18, wherein the first side surface of the LGP is perpendicular to the upper surface.
